(19) United States
(12) Patent Application Publication
(10) Pub. No.: US 2012/0223245 A1
(43) Pub. Date: Sep. 6, 2012

(54) ELECTRON BEAM SOURCE SYSTEM AND METHOD

(76) Inventors: John Bennett, Clyde Hill, WA (US); Jan P. Bennett, Margate (GB); Mark Troll, Seattle, WA (US)

(21) Appl. No.: 13/037,812

(22) Filed: Mar. 1, 2011

(51) Int. Cl. G21K 1/08; B82Y 30/00

(52) U.S. Cl. 250/396 R; 977/762

(57) ABSTRACT

An embodiment includes an electron beam source system having a first electron beam source unit with a substrate having a substrate-top end and a substrate-bottom end; and a first lens coupled to the substrate-bottom end defining a first aperture and having a lens-top end and a lens-bottom end. Further embodiments comprise an electron-emission region at the substrate-bottom end and aligned with the first aperture, the electron-emission region being operable to emit one or more electrons due to one or more photons contacting the electron-emission region, which may include passing through the substrate and into the electron-emission region, wherein the electron-emission region comprises a first doped portion of the substrate.

### BACKGROUND

Photolithography has been an area of active investigation for more than 40 years. The technology includes covering a target surface with a material layer known as a “resist.” The resist can be transformed by a patterned exposure to light, making a chemical or structural difference in the resist. This difference is used either to make parts of the resist permanent or weak. The difference may then chemically or physically exploited to enable the underlying object to be differently accessible for subsequent processing which may allow a various structures to be formed in the target based on an exposure pattern. This technique is used to fabricate integrated circuitry as well as other nanometer scale machinery such as pattern masks, accelerometers, chemical processing devices, sensors, and the like.

Lithography may use light as an exposure mechanism; however, electron beam sources may also be used. This may be desirable because electron beams may expose patterns with much finer detail than light beams, and electron optics may more efficient than the optics UV light, which would be needed to scale photolithography to dimensions that might rival the scale achievable by electron based lithography.

Unfortunately, electron beams are slow-acting when using conventional techniques. For example, a single electron beam may take days to expose a single wafer when using conventional techniques. However, practical manufacturing systems need to expose a complete wafer in a time scale on the order of a minute to be efficient. Therefore, current electron beam based lithography systems are not suitable for microfabrication of semiconductors.

Another problem in the photolithography industry is the cost of masks. Modern optical masks are extraordinarily complex and expensive in order to reliably generate sub-wavelength exposure details. Ultraviolet and x-ray masks are even more expensive and difficult to manufacture and use. Therefore, there is a need for systems that do not require a mask.

### SUMMARY

An embodiment includes an electron beam source system having a first electron beam source unit with a substrate having a substrate-top end and a substrate-bottom end; and a first lens coupled to the substrate-bottom end defining a first aperture and having a lens-top end and a lens-bottom end.

Further embodiments comprise a electron-emission region at the substrate-bottom end and aligned with the first aperture, the electron-emission region being operable to emit one or more electrons due to one or more photons passing through the substrate or directed onto the substrate and into the electron-emission region, wherein the electron-emission region comprises portion of the substrate.

Further embodiments include a plasmon-focusing region at the substrate-bottom end surrounding the electron-emission region operable to induce a plasmon effect about the aperture, wherein the plasmon-focusing region comprises a doped portion of the substrate or a tuned structure upon the substrate.

In some embodiments, the aperture increases in size from the lens-top end to the lens-bottom end via one or more stepped portions of the lens, and a stepped portion may be defined by two or more lens layers.

In further embodiments, the electron beam source system also includes at least one spacer positioned on the lens-bottom and extending therefrom from a spacer-top end, and includes a second lens coupled to a spacer-bottom end defining a second aperture and having a second lens-top end and a second lens-bottom end.

In some embodiments, the second aperture increases in size from the second lens-top end to the second lens-bottom end via one or more stepped portion of the second lens, and a stepped portion may be defined by two or more second lens layers.

In some embodiments, the first lens is operable to generate an electrostatic field that is operable to accelerate electrons through the first aperture and the second lens is operable to generate an electrostatic field that is operable to accelerate electrons through the second aperture. The electrostatic field may be approximately equal to or greater than 10 volts per micron and the second lens may be more positively charged than the first lens.

### BRIEF DESCRIPTION OF THE DRAWINGS

FIG. 1 depicts an electron beam source unit in accordance with one embodiment.

FIG. 2 depicts the electron beam source unit of FIG. 1 in accordance with another embodiment.

FIG. 3 depicts an electron beam source system comprising a plurality of electron beam source units of FIG. 2, in accordance with an embodiment, which is depicted projecting a plurality of electron beams onto a target.

FIG. 4 depicts an electron beam source system comprising a plurality of electron beam source units of FIG. 2, in accordance with an embodiment, which is depicted projecting a plurality of electron beams onto a target via an electron optics system.

FIG. 5a depicts an example of a raster pattern in accordance with an embodiment that may be generated on a target via an electron beam source system.

FIG. 5b depicts an example of a raster pattern in accordance with an embodiment that may be generated on a target via an electron beam source system.

FIG. 6 is a computational example of a focused electron beam in proximity to a target, in accordance with an embodiment.

FIG. 7 depicts an electron beam source unit in accordance with one embodiment.

FIG. 8 depicts an electron beam source system comprising a plurality of electron beam source units of FIG. 7, in accordance with an embodiment.

### DETAILED DESCRIPTION

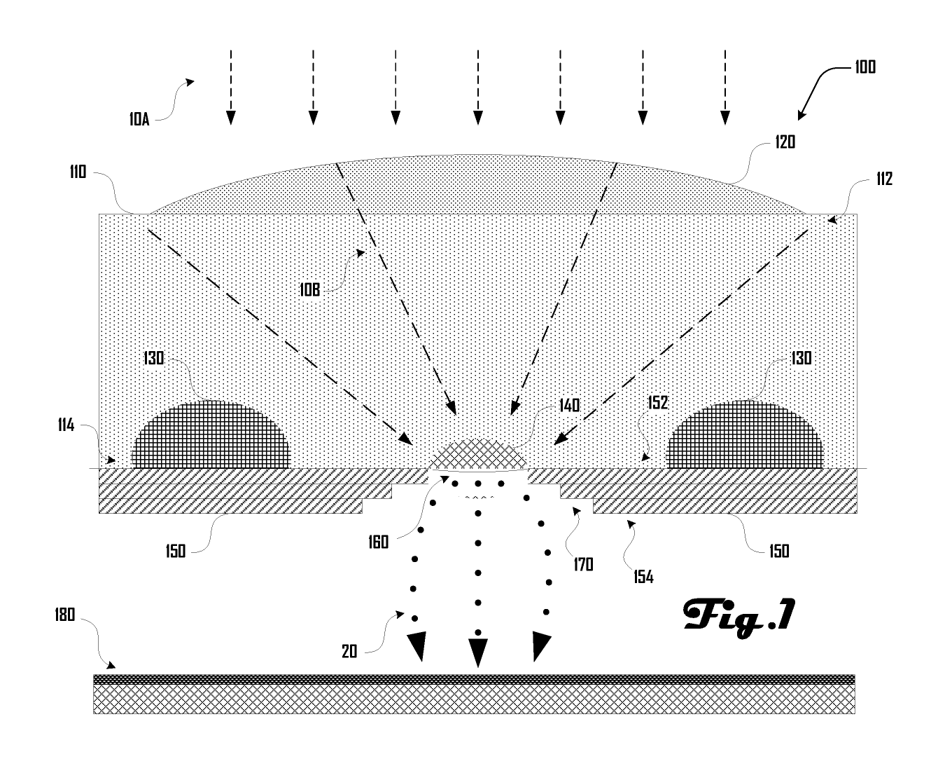

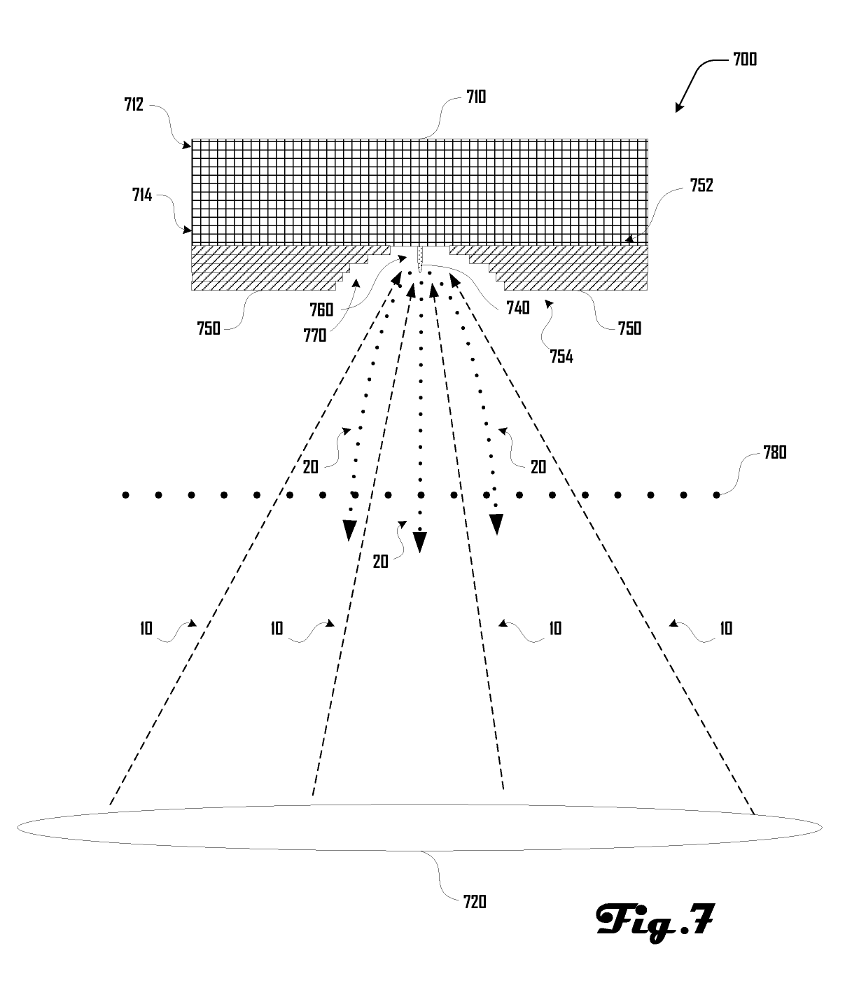

The present disclosure illustrates exemplary embodiments of an electron beam source unit 100, 700 (FIGS. 1 and 7). In some embodiments an electron-emission region 140, 740 may be operable to emit electrons 20 when the electron-emission region 140, 740 is exposed to light 10. Light 10 may be directed at an electron-emission region 140, 740 in various ways. For example, in one embodiment, light 10 may be directed at an electron-emission region 140 through a substrate 110, which supports a lens 150 (FIG. 1). In another embodiment, light 10 may be directed at an electron-emission region 740 but not through a substrate 710, which supports a lens 750 (FIG. 7).

FIG. 1 depicts an electron beam source unit 100 in accordance with one embodiment. The electron beam source unit 100 comprises a substrate 110 with a substrate-top end 112 and a substrate bottom-end 114, a plasmon-focusing region 130, and an electron-emission region 140. At the substrate-top end 112 there is a photon-focusing lens 120. At the substrate bottom-end 114 there is a first lens 150, which comprises a lens-top end 152, and a lens-bottom end 154. The lens 150 defines an aperture 160, which is defined by a shaped region 170.

The substrate 110 may be made of various suitable materials that are transparent or translucent to photons of one or more wavelengths. For example, in one embodiment, the substrate may be a rear-illuminated photo-electron emitter such as gallium arsenide (GaAs).

The electron-emission region 140 may be disposed at the substrate bottom-end 114 and proximate to the aperture 160 defined by the lens 150. The electron-emission region 140 may be operable to emit electrons when exposed to photons 10B. For example, the electron-emission region 140 may absorb energy from photons 10B, which may cause electrons 20 to be emitted.

The electron-emission region 140 may include any suitable structures, doping or compositions that provide for or induce electron-emission about the aperture 160. In one embodiment, the electron-emission region 140 may substantially comprise gallium arsenide or comprise gallium arsenide with a desired doping.

In one embodiment, the electron-emission region 140 may comprise a layer of gold, platinum, or the like, on the substrate bottom-end 114 about the aperture 160. Such a layer may be mono-atomic or multi-atomic. Such a layer may be desirable because it may support photo-emission of electrons while making the electron emission region 140 less prone to contamination.

In one embodiment, the electron-emission region 140 may comprise a plurality of quantum dots. For example, the electron-emission region 140 may comprise nano-crystals comprising gold or the like. Such a nano-crystal may comprise various desirable numbers of atoms, including tens, hundreds, thousands of atoms, or greater. In some embodiments, the quantum dots may be tuned by size to be emissive or otherwise enhance electron emission in the electron-emission region 140. In an embodiment, such quantum dots may be attached to a substrate that is not a photo-electron emitter, or that provides for limited photo-electron emission, which may include a substrate such as quartz.

Additionally, the substrate bottom-end 114 about the aperture 160, which may comprise the electron-emission region 140, may be shaped in various desirable ways. For example, FIG. 1 depicts such a region being convex; however, such a region may be flat, concave or any other desirable shape. In an embodiment, a desirable shape may be one where the electron-emission region 140 is compact or where electrons 20 tend to be emitted with a uniform initial direction.

The Plasmon-focusing region 130 may comprise one or more regions surrounding the aperture 160, which are operable to promote the Plasmon effect about the aperture 160. The Plasmon-focusing region 130 may comprise doping and/or structures which are operable to promote the Plasmon strength about the aperture 160. For example, the Plasmon-focusing region 130 may serve to focus energy into a light Plasmon or a Plasmon of light, which may be about the electron-emission region 140 or the aperture 160. In some embodiments, there may be a plurality of Plasmon-focusing regions 130, or the Plasmon-focusing region 130 may be absent.

The lens 150 may be located at the substrate bottom-end 114 and define an aperture 160 through which electrons 20 may pass when emitted at the electron-emission region 140. The lens 150 may be formed and shaped in various ways. For example, as depicted in FIG. 1, the lens may comprise a plurality of layers, which define a stepped shaped portion 170, which defines the aperture 160. Although FIG. 1 depicts a shaped portion 170 having rectangular steps defined by lens layers, with the aperture 160 increasing in size from the lens-top end 152 to the lens-bottom end 154, other shapes and configurations are possible. For example, the shaped portion 170 may be curved or linear, and the aperture 160 may be of uniform diameter, may increase or decrease in size from the lens-top end 152 to the lens-bottom end 154, or may be of varied diameter from the lens-top end 152 to the lens-bottom end 154. Additionally, the aperture 160 may be various shapes, include circular, rectangular or the like.

In an embodiment, the aperture 160 may comprise a diameter of about 10 nm. In an embodiment, the aperture 160 may comprise a diameter of about 1 nm, 2 nm, 5 nm, 15 nm, 20 nm, 25 nm, 30 nm, 35 nm, 40 nm, 45 nm, 50 nm or any other desirable size.

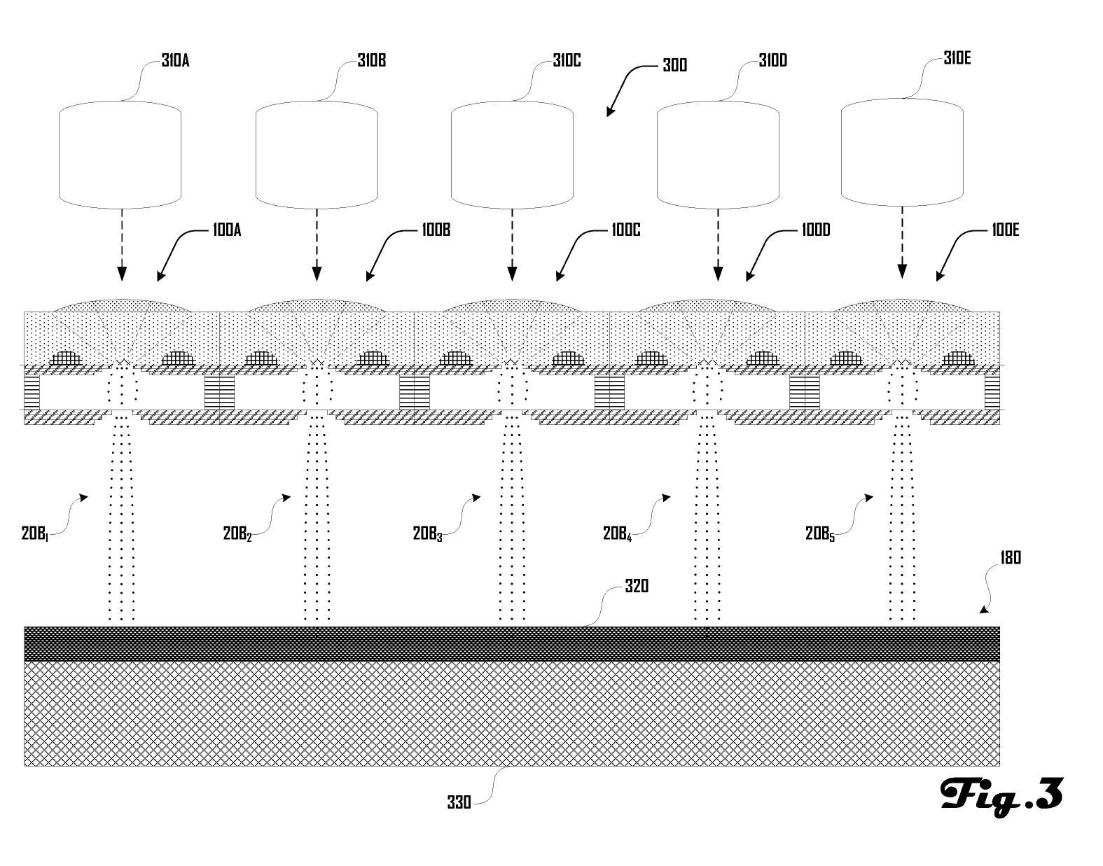

Additionally, although FIG. 3 depicts the lens 150 comprising three layers, the lens 150 may comprise a single layer or a plurality of layers. In an embodiment, the lens 150 may comprise a plurality of layers having different materials and profiles.

The lens 150 may be operable to accelerate and/or focus electrons 20 through the aperture 160 after the electrons 20 are emitted at the electron-emission region 140. For example, the lens 150 may act as a physical barrier or mask to electrons 20 or photons 10B, which have a velocity that is not towards the aperture 160. The lens 150 may comprise a material which reflects photons 10B, which may include chromium, or the like.

The lens 150 may also be operable to generate a shaped electric field about the aperture 160. The shaped electric field may be operable to accelerate and focus emitted electrons 20 in a focused beam toward a target 180. The shaped electric field may be generated by a voltage potential between the electron beam source unit 100 and a target 180. Additionally the geometry of the lens 160 including the shaped portion 170 may affect the shape of the electric field, and therefore the shape and size of the lens 160 may be modified to create an electric field having desired characteristics. Desired electric field characteristics may include an electric field that provides for a focused electron beam.

Additionally, the size of the shape of the lens 160 may be modified based on the liberation energy of electrons 20 from the electron-emission region 140 or the distance from the target 180. For example, the liberation energy of photo-emitted electrons 20 may be the difference between photon energy and band-gap energy of the electron-emission region 140, plus thermal energy (which may be about 100 microvolts per Kelvin). This liberation energy may serve as the basic scaling unit for the design. For example, if the liberation energy is 200 meV instead of 100 meV, then if one started with a design for 10 V/um fields one would have to double the field to maintain the same flight paths for the electrons 20. Alternatively, one may widen the lens 150 and such that electrons 20 in a beam may paint a wider spot.

Additionally, if one assumes the electron beam source unit 100 operates at a temperature of approximately 100° C. then the thermal energy may be around 40 meV. However, it may be possible lower the operating temperature of the electron beam source unit 100 and to configure the electron beam source unit 100 and select a wavelength of photons 10A such that “quiet” photons are generated that may be more easily focused and channeled into a vertical beam. In an embodiment, the lens 160 may be various thicknesses, for example about 1 nm, 5 nm, 10 nm, 50 nm, 100 nm, 500 nm, or 1000 nm.

The voltage potential between the electron beam source unit 100 and target 180 may about 10V per micron in some embodiments. In some embodiments, the voltage potential between the lens 160 and target 180 may be about or less than 1V per micron, about 5V per micron, about 15V per micron, about 20V per micron, about 25V per micron, about 30V per micron, about 40V per micron or more. In an embodiment, the lens 160 may be substantially the same voltage as the substrate 110.

As discussed herein, the electron beam source unit 100 is operable to generate an electron beam 20. For example, photons 10A may enter the substrate 110 at the substrate-top end 112, and the photons 10B may move toward the electron-emission region 140. In an embodiment, there may be a photon-focusing lens 120 which is operable to focus photons 10B at the electron-emission region 140. Photons 10B may travel through the substrate 110 and cause electron emission at the electron-emission region 140.

In an embodiment, it may be desirable to configure the electron beam source unit 100 such that emitted electrons 20 are emitted with minimal residual energy. For example, in an embodiment, it may be desirable for emitted electrons 20 to have a residual energy of 100 mV or less. In an embodiment, it may be desirable for emitted electrons to have a residual energy of less than or about equal to 10 mV, 50 mV, 200 mV, 500 mV, 750 mV or 1000 mV. Limited residual energy in electrons 20 may be desirable to limit electron trajectories that are away from the aperture 160, and to improve focus of the electron beam 20.

Minimal residual energy in emitted electrons 20 may be achieved in various ways. For example, in an embodiment, the electron beam source unit 100 may operate in low temperatures, which may be desirable because electrons 20 may be easier to control at reduced temperatures because band-gaps may become more sharply defined at lower temperatures. In an embodiment, an electron beam source unit 100 may be cooled by liquid nitrogen or the like, and may operate at various desirable temperatures including 65 Kelvin, 75 Kelvin or the like.

Additionally, in an embodiment, photons 10B may be restricted to photons having energies or wavelengths about, or slightly greater than the electron-emission region 140 band-gap (i.e., the minimal energy required to liberate an electron 20). Selected wavelengths may include any desirable wavelength, including infra-red through ultra-violet light. For example, if the electron-emission region 140 comprises gallium arsenide it may be desirable to use a near-infrared wavelength of light. However, in an embodiment where a gold or platinum surface is used, it may be desirable to use an ultraviolet wavelength of light. Limiting the wavelength of light may achieved via a light source that provides a limited wavelength, via a filter, or the like.

When electrons 20 are emitted at the electron-emission region 140, the electrons 20 may have velocities that are away from the aperture 160 (e.g., lateral to the aperture 160, toward the substrate-top end 112, or the like). To counteract these undesirable electron velocities, the lens 150 is operable to generate an electrostatic lens, that may direct the electrons 20 into a beam, and accelerate the electrons 20 out, away from, and perpendicular to the aperture 160.

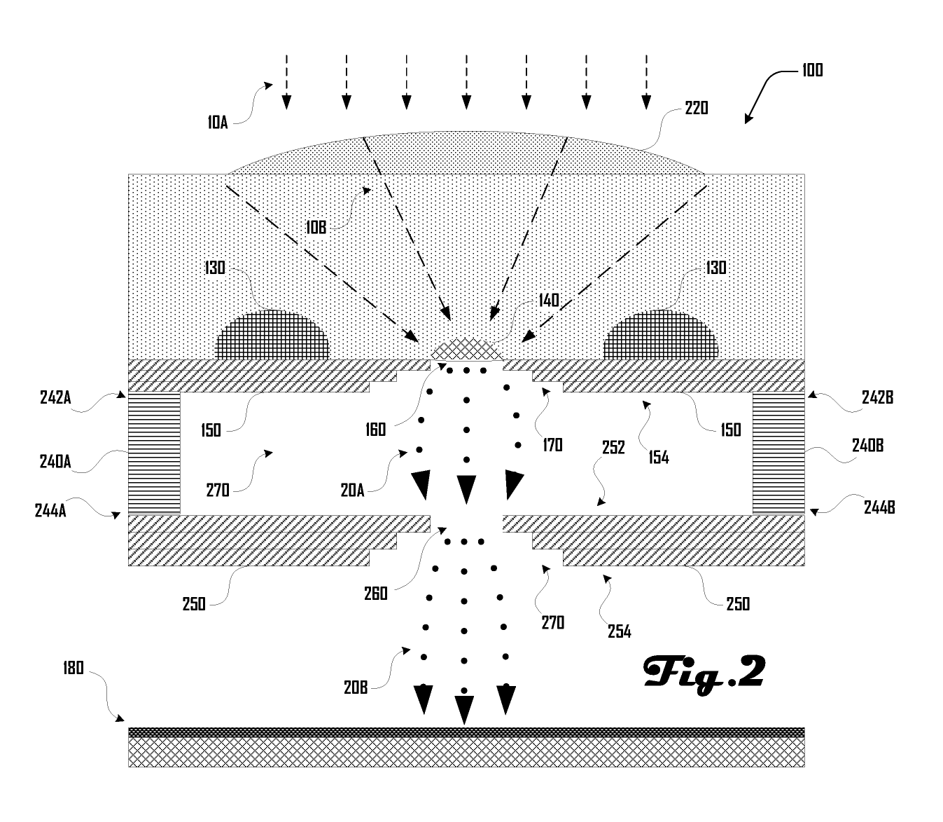

FIG. 2 depicts the electron beam source unit 100 of FIG. 1 in accordance with another embodiment. The beam source unit 100 of FIG. 2 further comprises a first and second spacer 240A, 240B which extend at a first and second spacer-top end 242A, 242B from the first lens 150 at the first-lens bottom end 154. At a first and second spacer bottom end 244A, 244B there is a second lens 250, which defines a second aperture 260. The second aperture 260 is defined by a second shaped portion 270. The second lens 250 further comprises a second-lens top and bottom end 252, 254. Additionally, the first and second lenses 150, 250 along with the first and second spacers 240A, 240B define a cavity 270.

The spacers 240A, 240B may be made of various suitable materials, and be various suitable heights. For example, in an embodiment, the spacers 240A, 240B may be about 100 nanometers to 10 microns. In one embodiment, the spacers 240A, 240B may be less than about 100 nanometers, or greater than 10 microns. In various embodiments, spacers 240A, 240B may be required to sustain mechanical stress due to electromagnetic fields associated with a lens 150, or the like. Accordingly, materials such as silicon dioxide, silicon nitride, aluminum oxides, may be desirable in some embodiments.

The second lens 250 may be made of any suitable material, have various configurations, and be various shapes as described above in relation to the first lens 150. In some embodiments, the first and second lens 150, 250 may be similar; however, in some embodiments, the first and second lens 150, 250 may not be similar and have different a shape, different materials, or different configuration. For example, in an embodiment, the second aperture 260 may be larger, smaller or the same size as the first aperture 160. In one embodiment, the second lens 250 may comprise a plurality of layers, which may be larger, smaller, or the same size as layers in the first lens 150.

Additionally, the first aperture 160 and second aperture 260 may be substantially aligned such that electrons 20A, 20B may pass and be focused therethrough. The second lens 260 may be operable to generate a vertical electric field, which may be provided by a bias between the second lens 250 and the electron-emission region 140 and/or the first lens 150. In an embodiment, the second lens 250 may be more positively charged than the first lens 150. In an embodiment, the second lens 250 may generate an electric field about or less than 1V per micron, about 5V per micron, about 15V per micron, about 20V per micron, about 25V per micron, about 30V per micron, about 40V per micron or more.

The second lens 250 and associated electric field may be shaped and configured to provide a focusing effect for electrons 20A passing within the cavity and electrons 20B which pass through the second aperture 260. Such a shaping or configuration may be similar or different than the configuration or shaping of the first lens 150 and associated electric field.

In addition to focusing electrons 20A, 20B, the second lens 250 and cavity 270 may be operable to reduce contamination of the electron-emission region 140 with particles that are not electrons. For example, in embodiments comprising lenses 150, 250 that focus electrons 20, such lenses 150, 250 may inherently be divergent for positive ions moving in the opposite direction, which may attract contamination away from the emission region 140 and towards the lenses 150, 250. Additionally, contaminants stuck to the lenses 150, 250 may not be as harmful as if such contaminants reach the electron-emission region 140, because since the lens geometry may be negligibly changed and the chemical nature of the lens layers may be robust. Accordingly, in an example where positive ions are present about the first or second lens 150, 250 they may be accelerated toward the first or second lens 150, 250 instead of away from it like negatively charged electrons 20A, 20B may be. In an embodiment, the first or second lens 150, 250 may comprise a material which allows positive ions to stick thereto (e.g., a “getter” coating such as barium, aluminum, magnesium, calcium, sodium, strontium, cesium, phosphorus, or the like). In an embodiment, various portions of the electron beam source unit 100 may operate in a vacuum.

In addition to the embodiments of an electron beam source unit 100 depicted in FIGS. 1 and 2, there may be numerous different embodiments at different configurations that are within the scope and spirit of the present disclosure. In one embodiment, there may a plurality of various elements or structures described in FIGS. 1 and 2, or any of such structures or elements may be absent. For example in an embodiment, there may be three or more lenses.

FIG. 3 depicts an electron beam source system 300 comprising a plurality of electron beam source units 100A-E of FIG. 2, in accordance with an embodiment, which is depicted projecting a plurality of electron beams 20B₁₋₅ onto a target 180, which comprises a resist layer 320 and a target substrate layer 330.

Each electron beam source unit 100A-E has a respective light source 310A-E. The light sources 310A-E may be any suitable photon 10A source, which may include one or more light emitting diode (LED), one or more laser, or the like. In some embodiments, the light sources 310A-E may produce one or a limited range of light wavelengths. In some embodiments, there may be one or more light sources 310A-E for each electron beam source unit 100, or there may be a plurality of electron beam source units 100 associated with a light source 310.

In various embodiments, light sources 310A-E may be individually or collectively modulated. For example, a light source 310A-E may be modulated by changing the intensity of the light source 310A-E or by modulating the length of the time which the light source is on and off. Some embodiments may include a Texas Instruments DLP mirror array, or the like.

In an embodiment, the each of the source units 100A-E may be separated, or may be contiguous. For example the substrate 110 (FIGS. 1 and 2) may be contiguous or may be physically separated. Similarly, the spacers 240A, 240B (FIG. 2) or lenses 150, 250 (FIGS. 1 and 2) may also be contiguously formed or separate. In one embodiment, the beam source system 300 may be a two dimensional array of electron beam source units 100.

The apertures 160, 260 (FIGS. 1 and 2) and associated electron beams (e.g., 20B₁₋₅) may be spaced at various distances in some embodiments. For example a given pair of apertures may be spaced about 1.0 micron apart. In some embodiments, a given pair of apertures may be spaced about 0.01 microns apart, about 0.1 microns apart, about 1.5 microns apart, about 2.0 microns apart, about 2.5 microns apart, 10 microns apart, 100 microns apart, or the like.

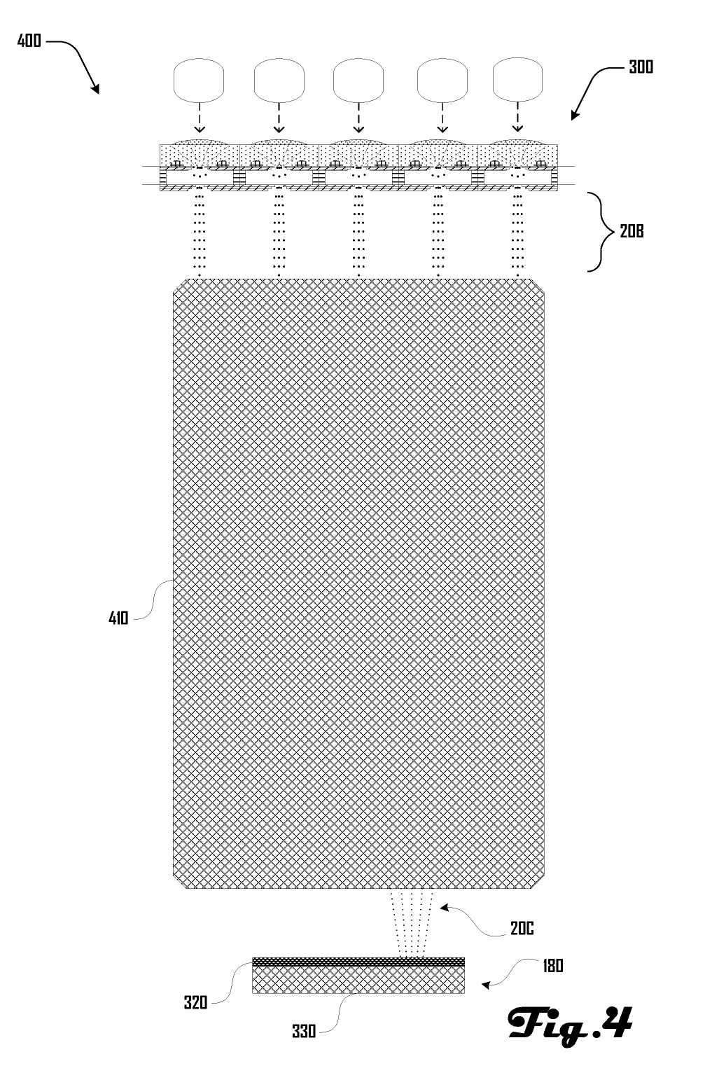

FIG. 4 depicts an electron beam source apparatus 400 comprising an electron beam source system 300 (FIG. 3) which is depicted projecting a plurality of electron beams 20C onto a target 180 via an electron optics system 410. As described herein, an electron beam source system 300 may generate a plurality of electron beams 20B, via a plurality of electron beam source units 100A-E (FIG. 2). The electron beams 20B may enter the electron optics system 410 and be converted into a focused electron beam 20C, which may be directed onto a target 180.

In an embodiment, various portions of the electron beam source unit 100, electron beam source system 300, or electron beam source apparatus 400 may operate in a vacuum. This may be desirable because electrons 20 may interact with particles (e.g. gas particles) and cause lack of focus or other disruption of electrons 20 in a beam.

Electron beam source units 100A-E (FIG. 2) of an electron beam source system 300 or electron beam source apparatus 400 may be collectively or individually calibrated before or during use so that an accurate and uniform quantity of electrons 20 can be delivered to a target 180. For example, differences in portions of the substrate 110, intensity of a light source 310, strength of an electric field associated with lenses 150, 250, physical differences in lenses 150, 250 may affect the quantity of electrons 20 that can be delivered to a target 180 by a given beam source unit 100. Therefore, by modifying the intensity of a light source 310 or strength of an electric field associated with one or both of the lenses 150, 250, it may be possible to modify the rate and quantity of electrons 20 that can be delivered to a target 180 by a given beam source unit 100. Accordingly, each electron beam source unit 100A-E can be calibrated such that the electron beam source units 100A-E deliver substantially the same quantity of electrons 20 to a target 180.

For example, calibration may be achieved by measuring the current flowing from electron beam source units 100A-E to the target 180 while illuminating just one of the electron beam source units 100A-E at a time. In some embodiments, it may be desirable to calibrate an electron beam source system 300 or electron beam source apparatus 400 at regular intervals, such as every minute or other desirable interval.

In an embodiment, one or more electron beam source units 100 can be replaceable within an electron beam source system 300 or electron beam source apparatus 400. This may be desirable because over the use-life of a given electron beam source unit 100, it may lose the ability to be calibrated so that it provides a desired quantity of electrons 20 to a target 180 at a desired rate. For example, portions of the electron beam source unit 100 may become contaminated, deformed, or the like. Therefore, such a defective electron beam source unit 100 may be replaced so that the electron beam source system 300 or electron beam source apparatus 400 may collectively perform as desired.

In further embodiments, large portions of an electron beam source system 300 or electron beam source apparatus 400 may be replaceable. For example, where the substrate 110 (FIGS. 1 and 2) defines a plurality of electron beam source units 100, the entire substrate 110 may be replaceable when one or more electron beam source units 100 are not functioning within desired parameters.

In various embodiment, an electron beam source unit 100, an electron beam source system 300, or electron beam source apparatus 400 may be used to project one or more electron beam 20 onto a target 180 so as to expose a desired pattern in a resist layer 320 (FIGS. 3 and 4). In some embodiments, each electron beam source unit 100 within an electron beam source system 300, or electron beam source apparatus 400 can generate an electron beam 20 simultaneously; however, in some embodiments, each individual electron beam source unit 100 within an electron beam source system 300, or electron beam source apparatus 400 can be selectively turned on or off, the electron beam 20 rate can be selectively changed.

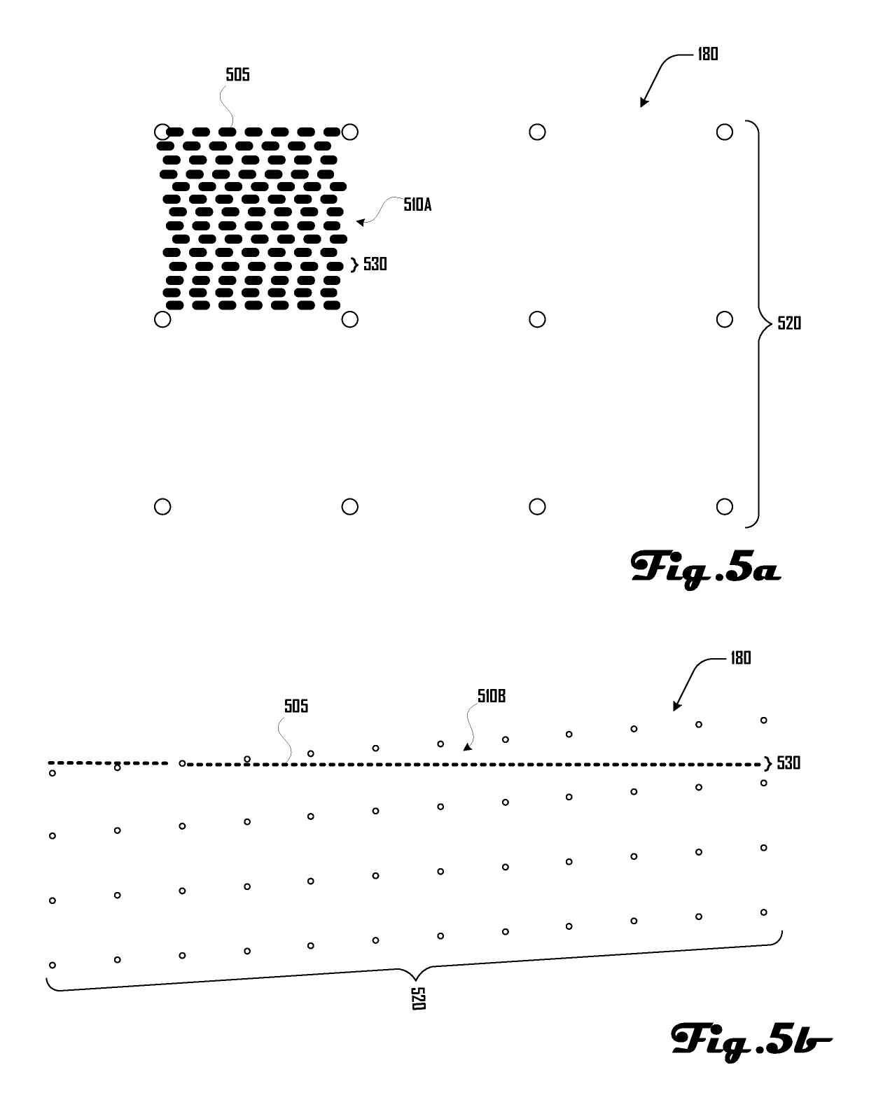

For example, FIGS. 5a and 5b depict examples of raster patterns 510A, 5108 in accordance with an embodiment that may be generated on a target 180 via one or more electron beam source unit 100, an electron beam source system 300, or electron beam source apparatus 400. The raster patterns 510A, 5108 comprise a plurality of dots 505, which may be an etching in the target 180, or the like.

Referring to FIG. 5a, the raster pattern 510A may be generated in various ways. For example, in one embodiment, a single electron beam source unit 100 may generate each of the plurality of dots 505. In one embodiment, a linear array of electron beam source units 100 may generate a plurality of rows 530 to form the raster pattern 510A. In a further embodiment, a two-dimensional matrix of electron beam source units 100 may form the raster pattern 510A where a plurality electron beam source units 100 operate simultaneously.

The dots 505 are shown as being oval in shape in FIGS. 5a and 5b, which may be achieved by an electron beam 20 focused into an oval shape, or may be achieved by a circular electron beam 20 being moved laterally. In various embodiments, electron beams 20 may be shaped into any desirable shape.

Additionally, the target 180 or one or more electron beam source units 100 may be moved to achieve a desired raster pattern 510A, 5108. For example, FIG. 5a depicts a raster pattern 510A that is aligned with a grid 520, which may be due to a certain alignment of the target 180 and one or more electron beam source unit 100. However, FIG. 5b depicts a raster pattern 510 having a single row 530 of dots 505, which is not aligned with the grid 520. This misalignment may be achieved by movement of the target 180 and/or one or more electron beam source unit 100. In further embodiments, a raster pattern 510A, 5108 may be shifted via modification of a field generated by an electron optics system 410 (FIG. 4), or the like, which may modify the direction of the electron beam 20C and thereby shift the raster pattern 510A, 5108.

In some embodiments, rasters may also be redundant and overlapping. For example, should one or more electron beam source unit 100 fail, a pattern generator may be reconfigured to generate a mission section using electron beam source units 100. This may allow imperfect, damaged, or un-calibrated arrays of electron beam source units 100 to remain operable, and may lengthen their useful life. In another example, drawing patterns may overlap N times and be drawn quickly so that (N−1) exposures are needed. Accordingly, groups of electron beam source units 100 can be depended on to make an exposure, and yet only add 1/N to the time taken for a full exposure. This may reduce the sensitivity to quality variations in individual electron beam source units 100.

In some embodiments, one or more electron beam source unit 100 may be used to generate any desirable pattern in a target, which may or may not be achieved by dot-matrix raster. For example, lines, curves, and regular or irregular shapes may be generated by one or more one or more electron beam source unit 100. In various embodiments, one or more electron beam source unit 100 may be used in the fabrication of semiconductors.

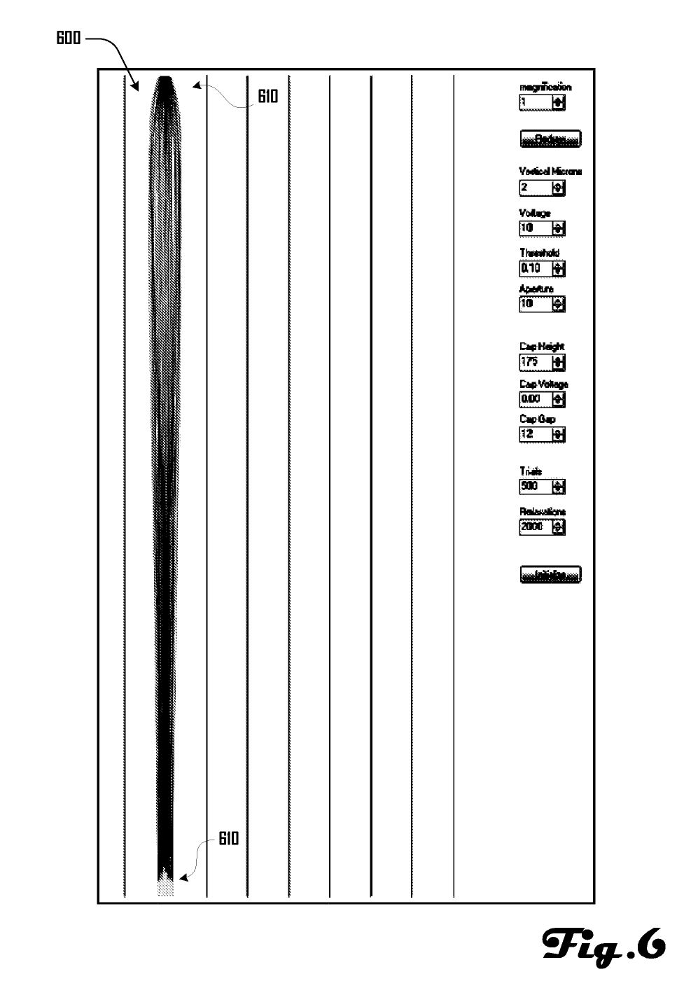

FIG. 6 is a computational example of a focused electron beam 600 in proximity to a target 180, in accordance with an embodiment. An electron-emission region 140 is at a top portion 610, and the target 180 is depicted at a bottom portion 620.

In this computational example, multiple electron paths have been computed and overlaid. The cross section of the computed beam delivered at the target is within a 40 nm wide region. Stand-off from source to target is set to 2 microns. Monochromatic photo-electrons emitted at the source in dispersed directions at an average energy distribution from 50 meV (milli electron volts) to 150 meV (equivalent to a 500K emitter temperature) are traced. In an embodiment the target 180 could be replaced with the location of an aperture 260 in a second lens 250 to enable sharper focus and higher energies to be delivered to the target 180.

FIG. 7 depicts an electron beam source unit 700 in accordance with one embodiment. The electron beam source unit 700 comprises a substrate 710, which supports an electron lens 750 and an electron-emission region 740.

The substrate 710 comprises a substrate-top end 712 and a substrate-bottom end 714, and the lens 750 is coupled to the substrate-bottom end 714. In an embodiment, the substrate 710 may comprise any suitable material. For example, the substrate may comprise a material as discussed above in relation to the substrate 110 (FIG. 1) or may comprise other suitable materials including a metal, plastic, composite material, or the like. The substrate 710 may be transparent, translucent or opaque to photons 10.

The electron-emission region 740 resides within an aperture 760 defined by the lens 750 and the substrate 710 on the substrate-bottom end 714, and is operable to emit electrons 20, when exposed to photons 10. In an embodiment, the electron-emission region 740 may comprise a dot, spike, nano-tube, nano-crystal, or the like, and may be centered in the aperture 760. For example, the electron-emission region 740 may comprise iron with a plurality of carbon nano-tubes grown thereon. In another example, the electron-emission region 740 may comprise cesium. In some embodiments, e.g., as depicted in FIG. 1, the electron-emission region 740 may be disposed in the substrate 710. Additionally, in some embodiments, the substrate 710 or other portion of the electron beam source unit 700 may comprise a Plasmon-focusing region, (e.g., as described herein in relation to FIG. 1).

The lens 750 may comprise a lens-top end 752 and a lens-bottom end 754 and as discussed herein, the lens 750 may comprise one or more layers. A stepped portion 770 of lens 750 that defines the aperture 760 may be stepped as shown or be another desirable shape or configuration, e.g., as described herein in relation to FIG. 1. Additionally, the lens 750 may comprise various suitable materials as described herein. In some embodiments, the lens 750 may have a high dielectric constant, may be non-conductive, or may be transparent or translucent to photons 10. In some embodiments, there may be a plurality of lenses 750 (e.g., as depicted in and described in relation to FIG. 2).

Additionally, the electron beam source unit 700 comprises a photon lens 720 that is operable to focus light 10 on the electron-emission region 740. As depicted in FIG. 7, the lens 750 may be aligned directly under the electron-emission region 740 or aperture 760; however, in some embodiments the lens 750 may be located in various suitable locations, and may not be located directly under or aligned with the electron-emission region 740 or aperture 760.

In an embodiment, photons 10 may be modulated and focused via the photon lens 720 toward the electron-emission region 740, which emits electrons 20 when contacted by the photons 10. Emitted electrons 20 may be focused by the electron lens 750 and the grid 780 via an electric field, or other method. For example, the grid 780 may generate a positive charge gradient which may be operable to accelerate electrons 20 in a desired direction.

In an embodiment, the lens 750 may be absent and a portion of the substrate 710 may be operable to focus, direct, or otherwise modify the velocity of electrons 20. In a further embodiment, the lens 750 may not comprise or define an aperture 760.

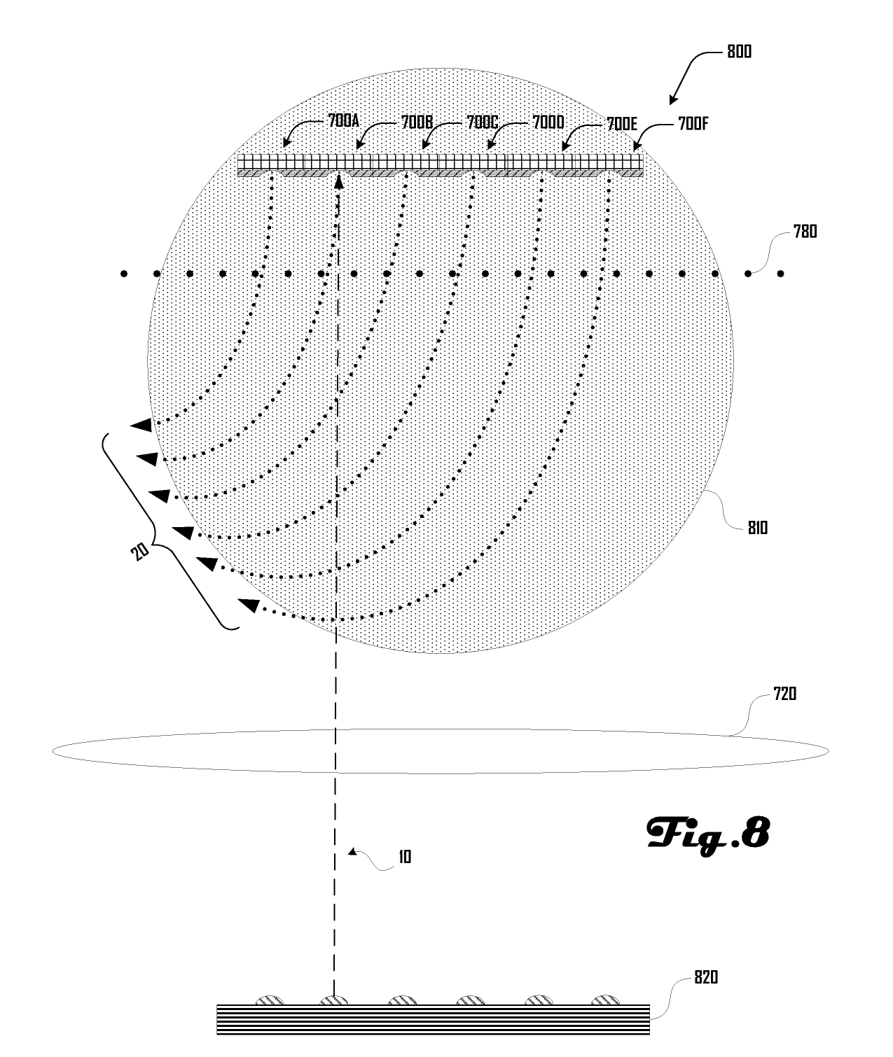

FIG. 8 depicts an electron beam source system 800 comprising a plurality of electron beam source units 700A-F, in accordance with an embodiment. The electron beam source system 800 further comprises a lensing field 810, which is operable to direct and focus electrons 20 that are generated by the electron beam source units 700A-F. For example, the lensing field 810 may be magnetic, and operable to direct, accelerate, or shift electrons 20 toward a target.

Additionally, the electron beam source system 800 comprises a light array 820, which may comprise a set of modulated light sources that are aligned to be focused by the photon lens 720, and directed toward a desired electron beam source unit 700A-F. For example, as depicted in FIG. 8 the light array 820 is depicted generating photos 10, which are focused by the photon lens 720 and directed toward an electron beam source unit 700B, which emits electrons 20.

Accordingly, from the foregoing it will be appreciated that, although specific embodiments have been described herein for purposes of illustration, various modifications may be made without deviating from the spirit and scope of the disclosure. Furthermore, where an alternative is disclosed for a particular embodiment, this alternative may also apply to other embodiments even if not specifically stated.

1. An electron beam source system comprising:
a first electron beam source unit comprising:
a substrate having a substrate-top end and a substrate-bottom end; and
a first lens coupled to the substrate-bottom end defining a first aperture and having a lens-top end and a lens-bottom end.

2. The electron beam source system of claim 1 further comprising an electron-emission region at the substrate-bottom end and aligned with the first aperture, the electron-emission region being operable to emit one or more electrons due to one or more photons passing through the substrate and into the electron-emission region.

3. The electron beam source system of claim 2 wherein the electron-emission region comprises a first doped portion of the substrate.

4. The electron beam source system of claim 2 further comprising a plasmon-focusing region at the substrate-bottom end surrounding the electron-emission region operable to induce a plasmon effect about the aperture.

5. The electron beam source system of claim 4, wherein the plasmon-focusing region comprises a doped portion of the substrate.

6. The electron beam source system of claim 4, wherein the aperture increases in size from the lens-top end to the lens-bottom end.

7. The electron beam source system of claim 6, wherein the aperture increases in size from the lens-top end to the lens-bottom end via one or more stepped portion of the lens.

8. The electron beam source system of claim 7, wherein the aperture increases in size from the lens-top end to the lens-bottom end via one or more stepped portions of the lens, and wherein a stepped portion is defined by two or more lens layers.

9. 9] The electron beam source system of claim 1, further comprising:
at least one spacer positioned on the lens-bottom and extending therefrom from a spacer-top end; and
a second lens coupled to a spacer-bottom end defining a second aperture and having a second lens-top end and a second lens-bottom end.

10. The electron beam source system of claim 9, wherein the second aperture increases in size from the second lens-top end to the second lens-bottom end.

11. The electron beam source system of claim 10, wherein the second aperture increases in size from the second lens-top end to the second lens-bottom end via one or more stepped portion of the lens.

12. The electron beam source system of claim 7, wherein the second aperture increases in size from the second lens-top end to the second lens-bottom end via one or more stepped portion of the second lens, and wherein a stepped portion is defined by two or more second lens layers.

13. The electron beam source system of claim 1, wherein the first lens is operable to generate an electrostatic field that is operable to accelerate electrons through the first aperture.

14. The electron beam source system of claim 13, wherein the electrostatic field is approximately equal to or greater than 10 volts per micron.

15. The electron beam source system of claim 9, wherein the first lens is operable to generate an electrostatic field that is operable to accelerate electrons through the first aperture, and wherein the second lens is operable to generate an electrostatic field that is operable to accelerate electrons through the second aperture.

16. The electron beam source system of claim 15, wherein the second lens is more positively charged than the first lens.

17. The electron beam source system of claim 2, wherein electrons are emitted with about less than 100 millivolts of energy.

18. The electron beam source system of claim 1, wherein the aperture is approximately 10 nanometers in diameter or less.

19. The electron beam source system of claim 1, further comprising a photon-focusing lens positioned on the substrate-top end and operable to focus photons at the first aperture.

20. The electron beam source system of claim 1 further comprising an electron-emission region at the substrate-bottom end and aligned with the first aperture, the electron-emission region being operable to emit one or more electrons contacting the electron-emission region,
wherein the electron-emission region comprises at least one of a dot, spike, nano-tube and nano-crystal.
